(19) United States
(12) Patent Application Publication
(10) Pub. No.: US 2019/0133373 A1
(43) Pub. Date: May 9, 2019

(54) PORTABLE COOKER ASSEMBLY

(71) Applicant: DOUGLAS G. HARRIS, JUSTIN, TX (US)

(72) Inventor: DOUGLAS G. HARRIS, JUSTIN, TX (US)

(21) Appl. No.: 15/808,850

(22) Filed: Nov. 9, 2017

(51) Int. Cl. A47J 37/07; A47J 27/00

(52) U.S. Cl. CPC A47J 37/0763; A47J 37/0786; A47J 27/002

(57) ABSTRACT

An assembly and method for the cooking of food is presented. The assembly of the present application is a singular device allowing versatility for the cook to prepare food either indoor or outdoor by operating effectively with different forms of heat generation while also being adaptable to various types of foods and work surfaces. Included is an upper portion and a lower portion concaved in shape to define an internal volume. The upper portion may pivot relative to the lower portion. An attachment member may be used to stabilize the lower portion to a work surface when the upper portion is opened. Heat may be provided via flame, charcoal and electrical heating element. Heat may be applied internally or externally to the lower portion. Additionally food may be cooked on a grate or in contact with the internal surface of the lower portion.

### BACKGROUND

### 1. Field of the Invention

The present application relates to a cooking device, and more particularly to multi-faceted cooking device designed for outdoor and indoor cooking in a plurality of different ways.

### 2. Description of Related Art

Multiple types of cooking equipment is found in the market today. Typically these are separated by the location for which they are used in. For example, stoves and ovens are predominantly thought of as indoor cooking equipment. Additionally, grills and smokers are thought of primarily as outdoor cooking equipment. Cooking equipment is used to cook food. The different manners in which this is done helps lend each type of equipment to the classification as an indoor or outdoor designation.

Currently there is missing a type of cooking device that is efficient and useful in cooking food in various different manners, whether indoor or outdoor. The idea of cooking is to produce elevated heat to a pan or dish such that food is cooked. This may be done through electricity (stove top) or via a fire (burner). Present day devices are typically cumbersome and do not allow it to work well with both types of heat producing methods. Additionally, the shape or size of the equipment is another hurdle that would need to be overcome to fit both indoor and outdoor cooking. Furthermore, different types of food are cooked in different types of pans. A singular device is needed to allow for the cooking of anything from mixed stir-fry to steak over a grill.

Although strides have been made with respect to cooking devices and equipment, considerable shortcomings remain. A singular device is needed to allow versatility to the cook so as to permit either indoor or outdoor cooking by operating effectively with both forms of heat generation while also being adaptable to various types of foods and work surfaces.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a front view of a portable cooking assembly according to an embodiment of the present application.

FIG. 2 is a side view of the portable cooking assembly of FIG. 1.

FIG. 3 is a top view of the portable cooking assembly of FIG. 1.

FIG. 4 is a side view of the portable cooking assembly of FIG. 2, resting on a work surface with a lid opened.

FIG. 5 is a side view of an attachment member in the portable cooking assembly of FIG. 1.

FIG. 6 is a rear view of the attachment member of FIG. 5 without fasteners.

FIG. 7 is a top view of a lower portion of the portable cooking assembly of FIG. 1.

FIG. 8 is a top view of a hinge assembly for the portable cooking assembly of FIG. 1.

FIG. 9 is an exploded view of the hinge assembly of FIG. 8.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The assembly and method in accordance with the present application overcomes one or more of the above-discussed problems commonly associated with traditional cooking equipment. In particular, the assembly of the present application is a singular device allowing versatility for the cook to prepare food either indoor or outdoor by operating effectively with both forms of heat generation while also being adaptable to various types of foods and work surfaces. The assembly is configured to selectively secure to a work surface for stability. Additionally, the assembly is configured to operate with both electric and fire heat generation methods. These and other unique features of the device are discussed below and illustrated in the accompanying drawings.

The assembly and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The assembly and method of the present application is illustrated in the associated drawings. The portable cooking assembly includes a lower portion and an upper portion, each being concaved in shape and having a circular rim. The upper portion is hinged to the lower portion and operates between an open and closed position. In the closed position, the rims of each portion are in contact. An internal volume is defined between the concaved shapes of the upper and lower portions. Heat is applied to the lower portion, either externally to the lower portion via a flame or a heating element, or internally within the internal volume along an internal surface of the lower portion via a fire or charcoal, sufficient to cook food located on an internal grilling grate or along the internal surface of the lower portion. The upper portion and the lower portion defining an internal volume. Additional features and functions of the device are illustrated and discussed below.

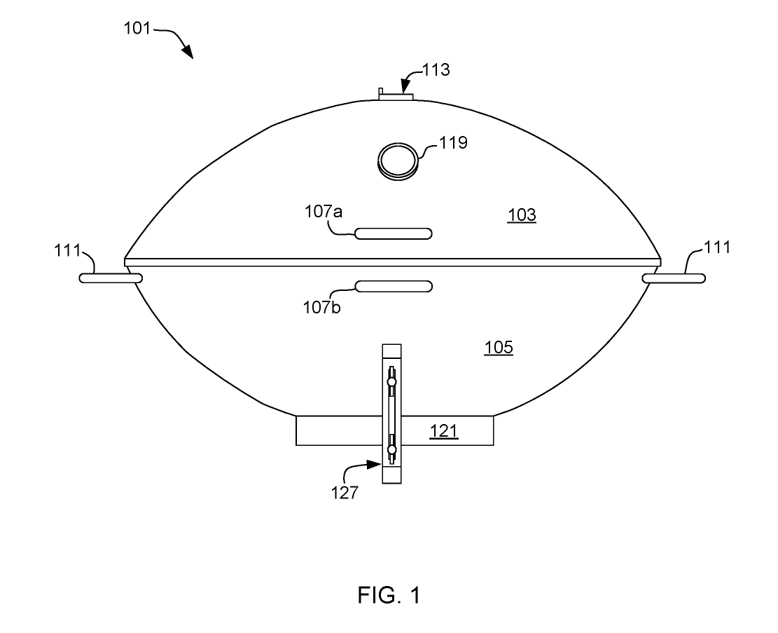

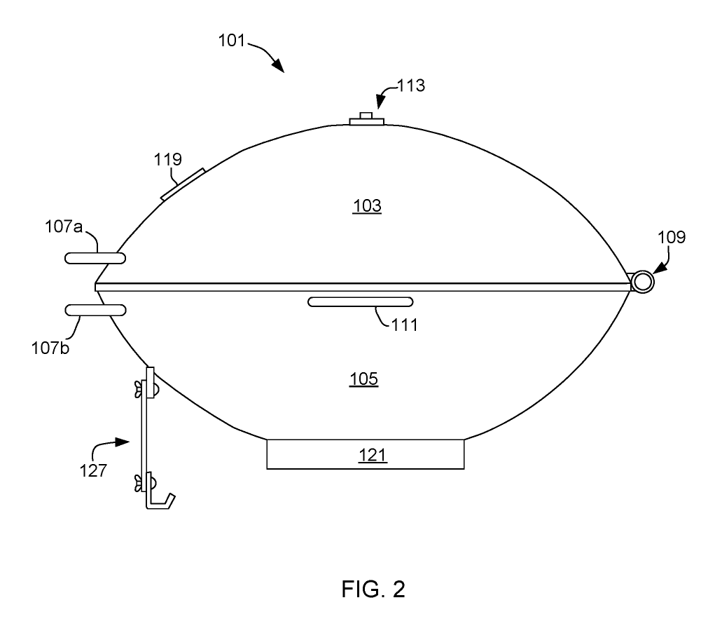

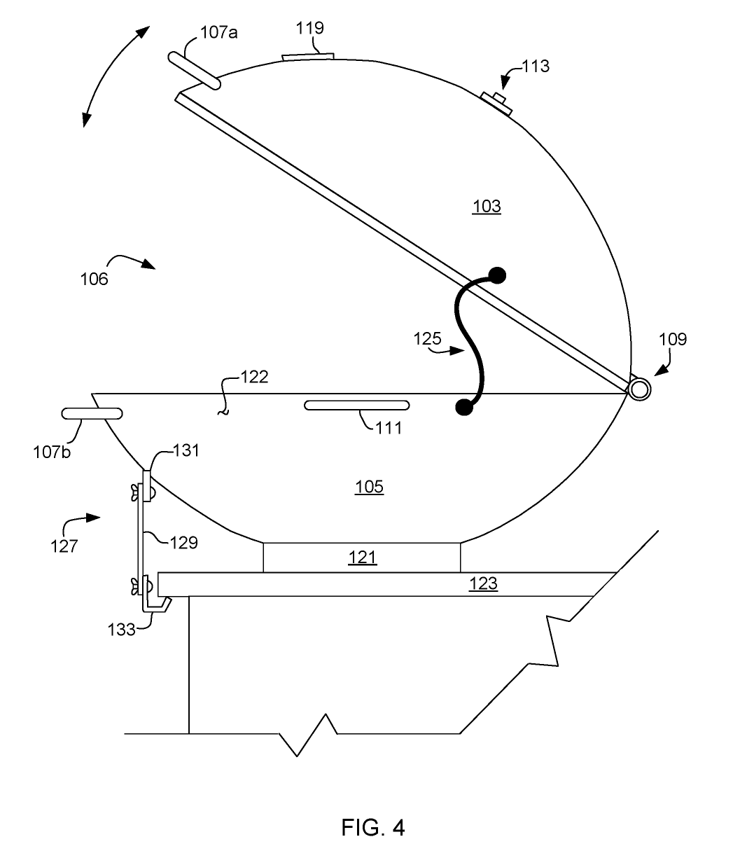

Referring now to the drawings wherein like reference characters identify corresponding or similar elements in form and function throughout the several views. FIGS. 1-3 illustrate assorted views of portable cooking assembly 101 according to the present application. Assembly 101 includes an upper portion 103 and a lower portion 105 that are each concaved such that the concave shape of each is facing the other. Each also has a circular rim at its opening. Upper portion 103 is configured to contact the rim of lower portion 105 when closed. Upper portion 103 partially overlaps lower potion 105 so as to maintain their proper alignment, the alignment being that they are centered over each other. As seen later in FIG. 4, upper portion 103 opens to allow access to an internal volume 106 defined within the combined shapes of each portion.

A plurality of handles 107a and 107b are used to permit a user the ability to position the assembly and operate each portion 103 and 105. Handle 107a is coupled to upper portion 103 and provides a location to grasp for opening and closing upper portion 103. Handle 107b is located in communication with lower portion 105. Handle 107b is configured to provide a grasping location for the user to stabilize lower portion 105 while upper portion 103 is pivoted about a hinge assembly 109. Handle 107b is optional in some embodiments depending on the configuration of assembly 101 and if other forms of stabilization for lower portion 105 is provided. Handles 111 are coupled to lower portion 105 and located on the relative sides of portion 105. Their function is to permit a grasping location for the user to transport assembly 101.

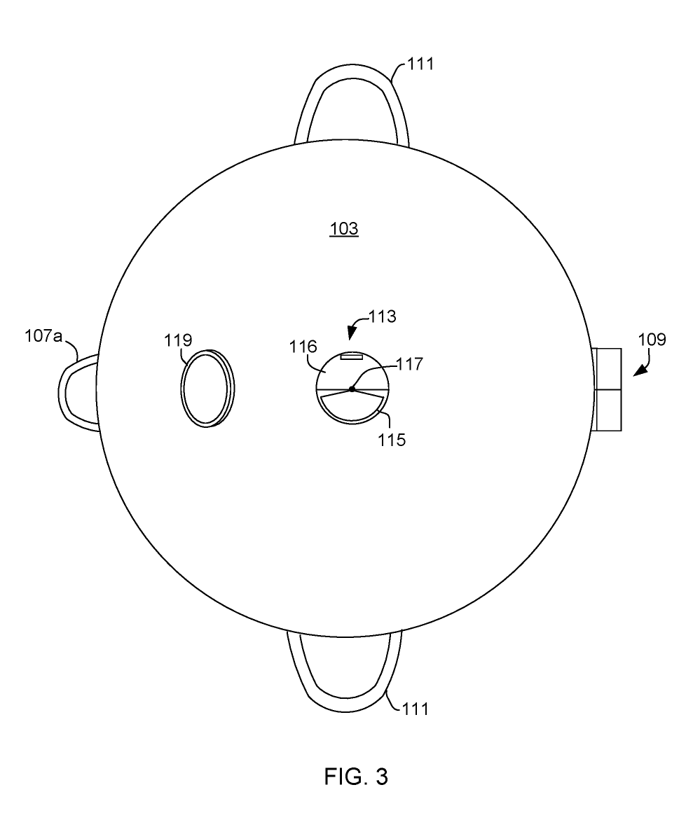

Upper portion 103 includes a vent 113 for regulating the passage of heat from internal volume 106. Vent 113 is configured to move relative to one or more apertures 115 formed in portion 103. In the example depicted, vent 113 has a plate member 116 (i.e metallic or aluminum) that is configured to include an opening in one section. Vent 113 rotates about as axis point 117 to selectively match its opening with that of aperture 115. When closed, member 116 covers aperture 115. Any amount of opening may be realized between fully closed and fully open. Vent 113 is shown fully open in FIG. 3.

Upper portion 103 may further include a thermostat 119. Thermostat 119 is configured to measure the temperature within internal volume 106. It is coupled to an exterior surface of portion 103 for display. The display may include mechanical indicators or digital displays for displaying the temperature within volume 106. It is understood that thermostats may work in different ways. Thermostat 119 may puncture through a portion of upper 103 to enhance its readings. It is also understood that thermostat 119 may include audio capabilities wherein a speaker and power supply are provided so as to audibly dictate temperature readings.

Referring now also to FIG. 4 in the drawings, a side view of assembly 101 is provided wherein upper portion 103 is pivoted about hinge assembly 109 and assembly 101 is shown secured to a work surface 123. Lower portion 105 further includes a base ring 121 coupled to and extending away from an outer surface 122 of portion 105. Portion 105 is supported by base 121 so as to stabilize it due to the contour of the concave shape of portion 105. Base 121 may take many different forms and is not herein limited to that described or depicted herein. Other embodiments may use a plurality of legs extending from surface 122, for example. Base 121 is centered around the deepest portion of lower portion 105 such that portion 105 is level about the rim to work surface 123.

On its own, base 121 provides stability to assembly 101 to prevent it from tipping during use when a user cooks food within it. However, as seen in FIG. 4, upper portion 103 pivots between an open and closed position. When closed, the rims of portions 103 and 105 make contact around their circumference. When opened, portion 103 is lifted and pivoted some degree above portion 105. Portion 103 can be fully opened such that it can be positioned such that its concave opening also faces relatively upward similarly to that of portion 105. The degree of opening depends on hinge assembly 109. It may also depend on the inclusion of straps 125. Straps 125 may be coupled to both portions 103 and 105 and extend a tether there between. The length of the tether would be sufficient to allow the center of gravity of portion 103 to be rotated beyond hinge assembly 109 such that gravity would work to apply a tension force to strap 125. Strap 125 would resist further pivoting of portion 103 and therefore portion 103 stays upright without the aid of the user.

It is understood that the weight of portions 103 and 105 may be substantial. They may be made from any known metallic material, including steel for example. The weight of portion 103 may act to induce a tipping effect upon portion 105 when opened, especially when resting in a fully opened position. Therefore assembly 101 may optionally further include an attachment member 127 configured to secure lower portion 105 to work surface 123. Member 127 is coupled to surface 122 and extends downward beyond the bottom of base 121. The overall length of member 127 is adjustable to permit its lengthening and its shortening so as to adapt to the thickness of work surface 123. Attachment member 127 is configured to grasp or contact another object and via is length adjustment, induce a compressive force between base 121 and member 127 around such other object. In this case the other object is depicted as work surface 123. Assembly 101 and member 127 may operate with any surface, including a counter, table, burner stand, vehicle, and so forth.

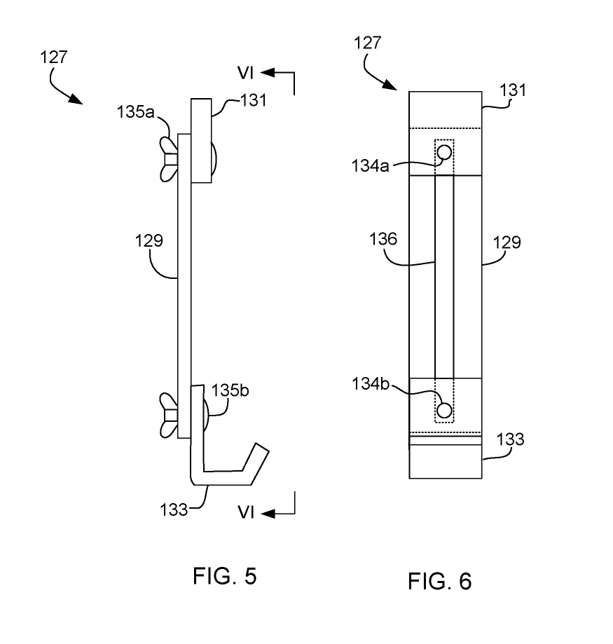

Referring now also to FIGS. 5 and 6 in the drawings, assorted views of attachment member 127 are depicted. These figures provide a more detailed view of member 127. FIG. 6 removes the fasteners from FIG. 5 for clarity to see the apertures therein. It is understood that other styles and configurations may be used herewith to accomplish the overall purpose of member 127. This is illustrating only one type of method of operation for member 127. In this embodiment, member 127 includes a track 129 that is in communication with a tab 131 and a contact member 133. Tab 131 is coupled to surface 122 of portion 105 and protrudes some distance away therefrom. Tab 131 includes an aperture 134a for acceptance of a releasable fastener 135a. Fastener 135a passes through aperture 134a and slot 136 of track 129 so as to bind them together. Fastener 135a can be loosened to allow track 129 to slide relative to tab 131 as fastener 135a passes through slot 136. Fastener 135a may be selectively tightened to secure the location of track 129 relative to tab 131.

Further included in member 127 is contact member 133. Much like tab 131, contact member 133 includes an aperture 134b. Fastener 135b passes through aperture 134b and slot 136 to secure the relative position of contact member 133 relative to track 129. Fastener 135b may be selectively loosened and/or tightened to permit adjustment of contact member 133. Contact member 133 may translate along the length of slot 136. The use of slot 136 allows the overall length of member 127 to be adjusted to various work surfaces 123. Contact member 133 includes a contact point (i.e. hook in this embodiment) that extends away from track 129 and back toward base 121. This contact point of contact member 133 is configured to press against work surface 123 as member 127 is adjusted. The compressive force created through adjustment of member 127 further secures portion 105 to work surface 123 so as to prevent tipping. Although member 127 may be located around any point on portion 105, it is understood that an ideal location would be an area opposite that of hinge assembly 109.

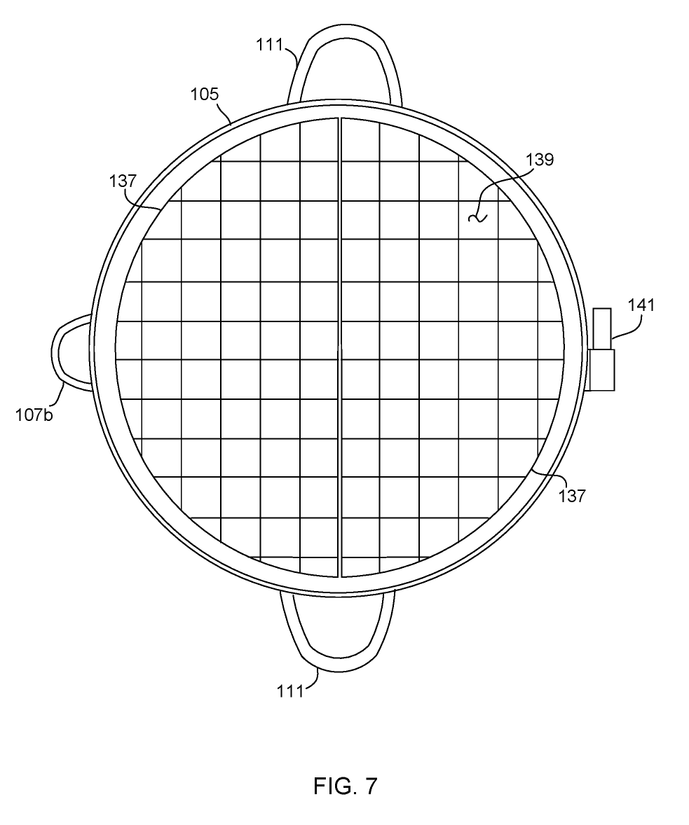

Referring now also to FIG. 7 in the drawings, a top view of lower portion 105 is illustrated. Lower portion 105 may further include a grilling grate 137. Grate 137 is configured to rest within the internal volume of portion 105 and contact an interior surface 139 of portion 105. Grate 137 is a semicircular shape and is configured to support food for cooking. A plurality of grates 137 are used to fully create an entire circular shape grate. It is understood that other embodiments may form grate 137 as a singular circular shape. Grate 137 contact surface 139 around its periphery so as to be elevated above the lowest portion of the internal volume.

During cooking with assembly 101, heat may be applied in various forms for the cooking of food. Assembly 101 may be used indoors by placing it on a stove top wherein base 121 contacts a burner. Additionally, a gas flame may be centered within base 121 indoors for cooking as well. Assembly 101 is functional for cooking outdoors too. Base 121 may be placed in contact with a burner (from a stand) to receive a flame and may even be placed directly over or within some coals in a fire pit. Assembly 101 may be configured where grate 137 is removed and the concave surface 139 is used as a cooking surface directly. In this manner, surface 139 is generally free of protrusions and recesses which may hinder a smooth cooking surface. Alternatively, grates 137 may be inserted and coals or a fire may be generated within the internal volume for more direct flame cooking to food on the grate(s). Assembly 101 is adept for all types and manners of cooking, including steaks, roasts, vegetables, cakes, desserts, oven cooking, grilling, wok style cooking, smoking, range top cooking and so forth.

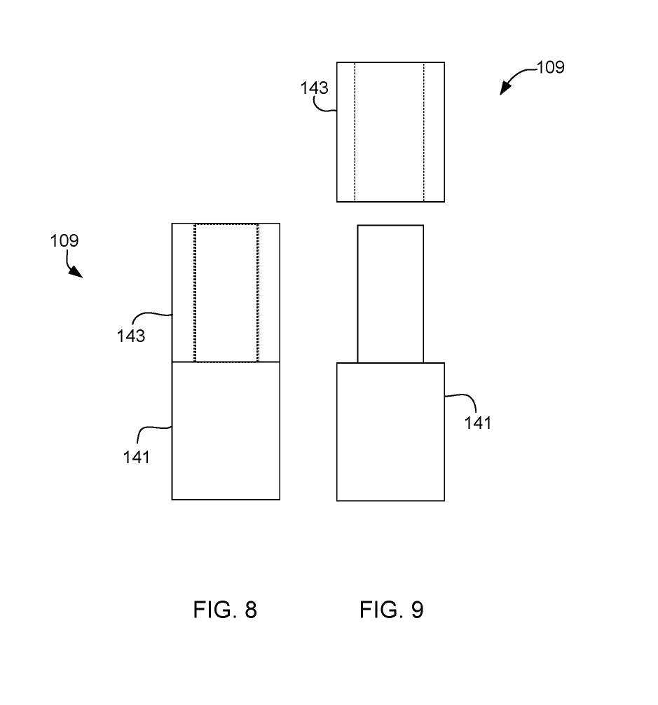

Referring now also to FIGS. 8 and 9 in the drawings, more detailed views of hinge assembly 109 are illustrated. As seen in FIG. 7, hinge assembly 109 is partially shown. Hinge assembly 109 includes a male end 141 and a female end 143 to permit portion 103 to pivot relative to portion 105. In this embodiment, female end 143 is coupled to portion 103 and male end 141 is coupled to lower portion 105. It is understood that ends 141 and 143 may be switched with respect to which portion they attach to. Each end 141 and 143 is coupled to a different portion 103 and 105. Hinge assembly 109 is configured to separate by translating ends 141 and 143 apart from one another. In an embodiment where straps 125 are used, straps 125 are releasable from either one or both of portions 103 and 105.

The current application has many advantages over the prior art including at least the following: (1) a versatile ability to cook food using various different heating sources; (2) inclusion of an adjustable attachment member for increased stability; and (3) a removable grate and smooth internal surface to the lower portion for increasing the options and types of food able to be cooked in the assembly.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A portable cooking assembly, comprising:
a lower portion being concaved in shape and having a circular rim;
an upper portion being concaved in shape and having a circular rim;
a hinge coupled to the lower portion and the upper portion, the hinge configured to permit relative movement of the upper portion to that of the lower portion, the upper portion configured to pivot about the hinge between an open and a closed position, the closed position defined as the circular rims of the upper portion and the lower portion making contact with each other;
wherein the upper portion and the lower portion defining an internal volume.

2. The assembly of claim 1, wherein the upper portion includes a vent for regulating the passage of heat from the internal volume.

3. The assembly of claim 2, wherein the vent selectively covers one or more holes in the upper portion.

4. The assembly of claim 1, wherein the upper portion includes a thermostat to measure the temperature within the internal volume.

5. The assembly of claim 1, wherein the lower portion includes a base ring extending away from an outer surface of the lower portion.

6. The assembly of claim 5, wherein the base ring is configured to stabilize the lower portion on a work surface.

7. The assembly of claim 5, wherein the base ring is centered about the lower portion.

8. The assembly of claim 1, wherein the lower portion includes an attachment member configured to secure the lower portion to a work surface.

9. The assembly of claim 8, wherein the attachment member extends below an outer surface of the lower portion.

10. The assembly of claim 8, wherein the length of the attachment member is adjustable.

11. The assembly of claim 8, wherein the attachment member includes a slidable track to permit length adjustment.

12. The assembly of claim 11, wherein the slidable track is releasably coupled to a tab on the lower portion, the position of the slidable track being adjustable relative to the tab.

13. The assembly of claim 11, wherein the attachment member includes a contact member in releasable communication with the slidable track, the position of the contact member being adjustable relative to the slidable track.

14. The assembly of claim 8, wherein the attachment member includes a contact member configured to contact the work surface, the relative location of the contact member being adjustable relative to the lower portion.

15. The assembly of claim 14, wherein adjustment of the attachment member induces a compressive force on the work surface between the contact member and the base ring.

16. The assembly of claim 1, wherein the lower portion includes a grilling grate within the internal volume, the grilling grate configured to support food.

17. The assembly of claim 16, wherein the grilling grate is semicircular.

18. The assembly of claim 16, wherein an internal surface of the lower portion is a cooking surface.

19. The assembly of claim 1, wherein the hinge is comprised of a male end and a female end to permit the hinge to selectively separate.

20. The assembly of claim 19, wherein the upper portion is detachable from the lower portion about the hinge.
